(19) United States
(12) Patent Application Publication
(10) Pub. No.: US 2026/0107064 A1
(43) Pub. Date: Apr. 16, 2026

(54) CAMERA FOCAL LENGTH ADJUSTMENT

(71) Applicant: Ford Global Technologies, LLC, Dearborn, MI (US)

(72) Inventors: Brad Alan Ignaczak, Canton, MI (US); Martin van Hoeckel, Woodstock/Ontario (CA); Jonathan Diedrich, Carleton, MI (US); David Hiskens, Ypsilanti, MI (US)

(73) Assignee: Ford Global Technologies, LLC, Dearborn, MI (US)

(21) Appl. No.: 18/916,859

(22) Filed: Oct. 16, 2024

(51) Int. Cl. H04N 23/67; H04N 23/11; H04N 23/69

(52) U.S. Cl. CPC H04N 23/67; H04N 23/11; H04N 23/69

(57) ABSTRACT

A system comprising a computer having a processor and a memory, the memory storing instructions executable by the processor to, based on an operational scenario of a vehicle, determine a target focal length, the vehicle including a camera having an adjustable focal length; actuate the camera to adjust the adjustable focal length to the target focal length; and actuate the camera to capture image data while the adjustable focal length of the camera is at the target focal length. The target focal length corresponds to a wavelength of light associated with the operational scenario.

### BACKGROUND

Modern vehicles typically include cameras. The cameras can detect electromagnetic radiation in some range of wavelengths. Cameras may detect visible light, infrared radiation, ultraviolet light, or some range of wavelengths including visible, infrared, and/or ultraviolet light. Cameras can be a charge-coupled device (CCD), complementary metal oxide semiconductor (CMOS), etc.

### BRIEF DESCRIPTION OF THE DRAWINGS

FIG. 1 is a block diagram of an example vehicle.

FIG. 2 is a diagrammatic interior view an example camera.

FIG. 3 is an illustration of example image data.

FIG. 4 is a flowchart diagram of an example process to adjust focal length.

### DETAILED DESCRIPTION

Techniques described herein can actuate a sensor to adjust a focal length based on an operational scenario of a vehicle. A vehicle computer may determine an operational scenario of a vehicle and a corresponding specification of a vehicle subsystem which utilizes image data. The computer may actuate the sensor to capture image data of a wavelength of electromagnetic radiation specified by the specification of the vehicle subsystem. The operational scenario is the operation of a specific vehicle subsystem either in a specific manner or to perform a specific task. As an example, the operational scenario may be a video call or driver monitoring. The techniques described herein allow for a camera to obtain image data measured at specified wavelengths of electromagnetic radiation such that the same camera may be used to provide data for various systems which may operate using image data measured at differing wavelengths. For example, a video call may use image data measured at a wavelength in the visible spectrum, and driver monitoring may use image data measured at a wavelength in the near-infrared spectrum.

Accordingly, included in the present disclosure is a system comprising a computer having a processor and a memory, the memory storing instructions executable by the processor to: based on an operational scenario of a vehicle, determine a target focal length, the vehicle including a camera having an adjustable focal length, actuate the camera to adjust the adjustable focal length to the target focal length, and actuate the camera to capture image data while the adjustable focal length of the camera is at the target focal length, wherein the target focal length corresponds to a wavelength of light associated with the operational scenario.

The wavelength may be associated with the operational scenario based on a specification of a vehicle subsystem.

The specification may be a specified light wavelength of the vehicle subsystem.

The operational scenario may be that an occupant of the vehicle is on a video call.

The operational scenario may be monitoring a status of an operator of the vehicle.

The wavelength of light associated with the operational scenario may be near-infrared light.

The wavelength of light associated with the operational scenario may be visible light.

The wavelength of light associated with the operational scenario may be shortwave infrared light.

The computer may select the operational scenario from a plurality of prestored operational scenarios.

Each of the prestored operational scenarios may have a respective relative priority associated with that prestored operational scenario, and the computer may select the operational scenario from the prestored operational scenarios based on the relative priorities.

The prestored operational scenarios may include a first prestored operational scenario and a second prestored operational scenario, the computer may determine that the target focal length is a first target focal length in response to selecting the first prestored operational scenario as the operational scenario, and determine that the target focal length is a second target focal length in response to selecting the second prestored operational scenario as the operational scenario.

The wavelength of light may be selected from a first wavelength of light associated with a first operational scenario and a second wavelength of light associated with a second operational scenario.

The prestored operational scenarios may include a first prestored operational scenario and a second prestored operational scenario, the computer may determine that the target focal length is between a first target focal length of the first prestored operational scenario and a second target focal length of the second prestored operational scenario.

A method comprises: based on an operational scenario of a vehicle, determining a target focal length, the vehicle including a camera having an adjustable focal length, actuating the camera to adjust the adjustable focal length to the target focal length, and actuating the camera to capture image data while the adjustable focal length of the camera is at the target focal length, wherein the target focal length corresponds to a wavelength of light associated with the operational scenario.

The wavelength associated with the operational scenario may be based on a specification of a vehicle subsystem.

The method may further include selecting the operational scenario from a plurality of prestored operational scenarios.

Each of the prestored operational scenarios may have a respective relative priority associated with that prestored operational scenario, and the method may further include selecting the operational scenario from the prestored operational scenarios based on the relative priorities.

The prestored operational scenarios may include a first prestored operational scenario and a second prestored operational scenario, and the method may further include determining that the target focal length is a first target focal length in response to selecting the first prestored operational scenario as the operational scenario, and determining that the target focal length is a second target focal length in response to selecting the second prestored operational scenario as the operational scenario.

The wavelength of light may be selected from a first wavelength of light associated with a first operational scenario and a second wavelength of light associated with a second operational scenario.

The prestored operational scenarios may include a first prestored operational scenario and a second prestored operational scenario, the method may further include determining that the target focal length is between a first target focal length of the first prestored operational scenario and a second target focal length of the second prestored operational scenario.

### Exemplary System Elements

The vehicle 100 may be any passenger or commercial automobile such as a car, a truck, a sport utility vehicle, a crossover, a van, a minivan, a taxi, a bus, ICE (Internal Combustion Engine), BEV (Battery Electric Vehicle), hybrid, a PHEV (Plug-in Hybrid Electric Vehicle), etc. The vehicle 100 includes a computer 104, a camera 106, components 108, a display 110, and a communications network 114.

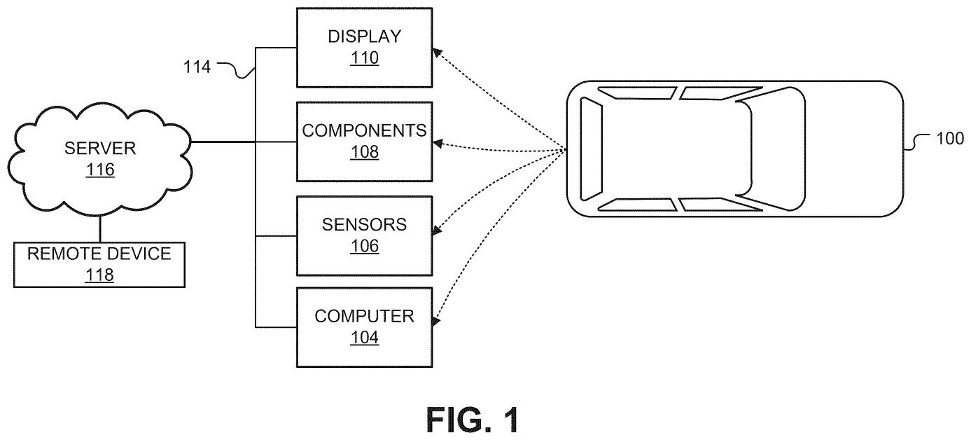

With reference to FIG. 1, the vehicle 100 includes the computer 104 having a memory that includes instructions executable by a processor of the computer 104 to carry out processes and operations including as described herein. For example, the memory stores instructions executable by the processor, including instructions to actuate a camera to adjust a focal length to a target focal length based on an operational scenario of the vehicle.

The vehicle computer 104 includes a processor and a memory. The memory includes one or more forms of computer readable media, and stores instructions executable by the computer 104 for performing various operations, including as disclosed herein. For example, the computer 104 can be a generic computer with a processor and memory as described above and/or may include an electronic control unit ECU or controller for a specific function or set of functions, and/or a dedicated electronic circuit including an ASIC (application specific integrated circuit) that is manufactured for a particular operation (e.g., an ASIC for processing sensor data and/or communicating the sensor data). In another example, the computer 104 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design to describe digital and mixed-signal systems such as FPGA and ASIC. For example, an ASIC is manufactured based on VHDL programming provided pre-manufacturing, whereas logical components inside an FPGA may be configured based on VHDL programming (e.g., stored in a memory electrically connected to the FPGA circuit). In some examples, a combination of processor(s), ASIC(s), and/or FPGA circuits may be included in a computer 104. The computer 104 may be multiple computers coupled together.

The memory can be of any type (e.g., hard disk drives, solid state drives, servers, or any volatile or non-volatile media). The memory can store the collected data sent from the sensors 106. The memory can be a separate device from the computer 104, and the computer 104 can retrieve data stored by the memory via the communications network 114 in the vehicle 100 (e.g., over a CAN bus, a wireless network, etc.) Alternatively or additionally, the memory can be part of the computer 104 (e.g., as a memory of the computer 104).

The computer 104 may be communicatively coupled via the communication network 114 with the camera 106, the components 108, and the displays 110 in the vehicle 100. The computer 104 is generally arranged for communications on the communication network 114 that can include a bus in the vehicle 100 such as a controller area network CAN or the like, and/or other wired and/or wireless mechanisms. Alternatively or additionally, in cases where the computer 104 actually comprises a plurality of devices, the communication network 114 may be used for communications between devices represented as the computer 104 in this disclosure. Further, as mentioned below, various controllers and/or sensors such as the camera 106 may provide data to the computer 104 via the communication network 114.

The vehicle 100 may include one or more displays 110. The display 110 renders visual data for viewing by occupants of a vehicle 102. The display 1110 can display visual data in monochrome or color and the visual data can be updated at a frame rate, which can be 60 frames per second, for example. Displayed visual data can be a static image, in which the majority of the area does not change from frame to frame, or a dynamic image, where the majority of the area changes from frame to frame. The display 110 may, for example, render an image of a video call.

The computer 104 may include programming to operate one or more of vehicle components such as propulsion (e.g., control of speed in the vehicle 100 by controlling one or more of an internal combustion engine, electric motor, hybrid engine, etc.), steering, interior and/or exterior lights, the displays 110, etc., as well as to determine whether and when the computer 104, as opposed to a human operator, is to control such operations.

The camera 106 may provide data about occupants of the vehicle 100. The camera 106 can detect electromagnetic radiation in some range of wavelengths. For example, the camera 106 may detect visible light, infrared radiation, ultraviolet light, or some range of wavelengths including visible, infrared, and/or ultraviolet light. For example, the camera 106 can be a charge-coupled device (CCD), complementary metal oxide semiconductor (CMOS), or any other suitable type.

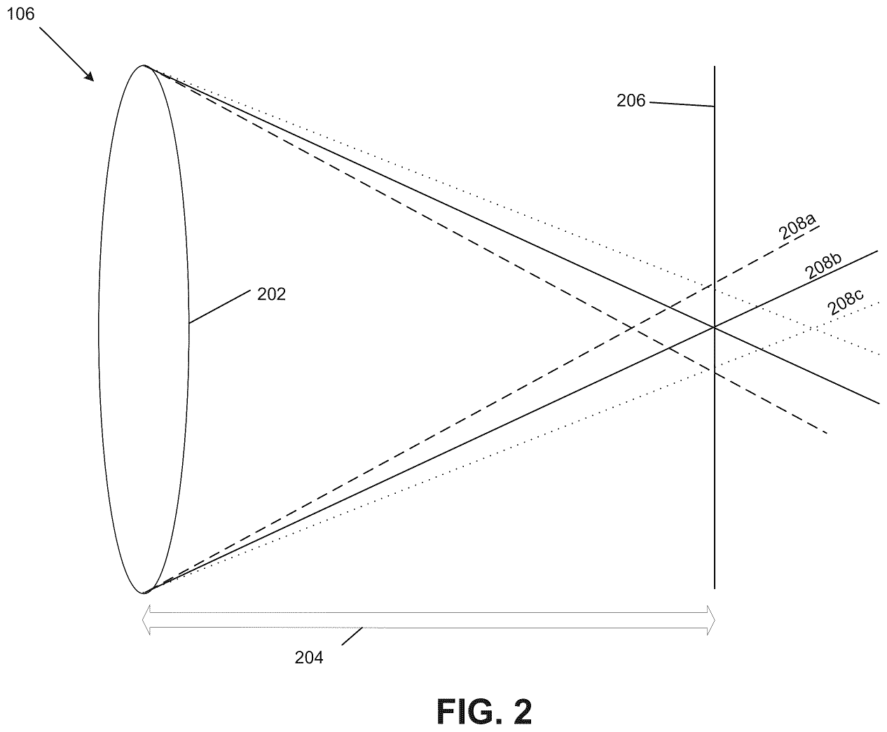

Referring now to FIG. 2, the camera 106 includes a lens 202 and a focal plane 206. The lens 202 may be a refractive lens such that electromagnetic radiation travelling through the lens 202 may be separated into ranges of wavelengths converging at distinct points. The focal plane 206 captures an image according to the light that the lens 202 directs onto the focal plane 206. For example, the focal plane 206 may be an image sensor such as a complementary metal-oxide-semiconductor (CMOS) or charge-coupled device (CCD) sensor.

The camera 106 has a focal length 204. Focal length 204 as used herein refers to the back focal distance of the camera 106. Back focal distance is the distance between the rear of the lens 202 and the focal plane 206 on which the image is captured by the camera 106. The computer 104 may adjust the focal length 204 by actuating at least one of the lens 202 or the focal plane 206 to be nearer or farther apart (e.g., by actuating a housing of the lens 202 or plane 206) as will be discussed in further detail below.

As mentioned above, the camera 106 may capture electromagnetic radiation of specified wavelengths in image data. The lens 202 may separate the wavelengths of electromagnetic radiation such that separate bands of wavelengths converge at distinct points. As shown in the example in FIG. 2, the lens 202 may separate incoming electromagnetic radiation into bands of wavelengths that converge at different longitudinal distances from the lens 202. In the present example the lens 202 separates the incoming light into green light 208a (represented by the dashed lines), red light 208b (represented by the solid lines), and near-infrared light 208c (represented by the dotted lines). However, the lens 202 may separate further bands of wavelengths in the electromagnetic spectrum.

The lens 202 may separate electromagnetic radiation such that different bands of wavelengths converge on the focal plane 206 depending on the focal length 204 between the lens 202 and the focal plane 206.

As an example, the lens 202 may separate electromagnetic radiation into bands such that visible light (e.g., light of wavelengths from 380 nm-740 nm) converges on the focal plane 206 whereas bands of wavelengths outside the range of visible light converge before or after the focal plane 206. Alternatively, or additionally, the lens 202 may separate incoming light into yet smaller bands (e.g., only “green light” converging on the focal plane 206 whereas red light may converge after the focal plane 206 and blue light converge before the focal plane 206). As a further example, the lens 202 may separate incoming light such that a band of wavelength corresponding to near-infrared light (e.g., 750 nm-2500 nm) converges on the focal plane 206. Yet further, the lens 202 may separate incoming light such that a band of wavelength corresponding to shortwave infrared light (e.g., 1000 nm-2700 nm) converges on the focal plane 206.

At any given time, the vehicle 100 is in one or more operational scenarios. For the purposes of this disclosure, “operational scenario” is defined as the operation of one or more specific vehicle subsystems either in a specific manner or to perform a specific task. A vehicle subsystem may be any system such as a driver monitoring system, a video communication system, a passenger monitoring system, etc. An operational scenario may, for example, be a video call for an occupant of the vehicle 100, monitoring a status of an operator of the vehicle 100 (i.e., driver monitoring), detecting objects within the vehicle 100, etc. The various vehicle subsystems may each use image data from the camera 106. As described below, the computer 104 may actuate the camera 106 depending on the operational scenario of the vehicle 100.

Each operational scenario has a wavelength of light associated with the operational scenario. The wavelength associated with an operational scenario may be based on a specification of the vehicle subsystem used for the operational scenario. For example, vehicle subsystems that use image data may use only specified bands of wavelengths of electromagnetic radiation from the image data. The computer 104 may store specifications of the vehicle subsystems specifying bands of wavelengths associated with the vehicle subsystems. The wavelength of light associated with the operational scenario may be near-infrared (NIR) light. For example, a driver monitoring system may use the band 920 nm-960 nm from the image data. The driver monitoring system may include a NIR illuminator positioned to illuminate the operator. NIR light is useful for driver monitoring because NIR light is not visible to the operator. The wavelength of light associated with the operational scenario may be visible light. For example, a video communication system may use the band 520 nm-560 nm from the image data, etc. Visible light is useful because the image data may be viewed by the other caller in the video call. Therefore, operational scenarios may have associated wavelengths which correspond to the specifications of vehicle subsystems. Table 1 below shows an example lookup table. The computer 104 may store the lookup table in memory. Table 1 specifies operational scenarios, the wavelengths which the vehicle subsystems require in image data for the operational scenarios, and the focal length 204 at which the band of wavelength will converge on the focal plane 206.

TABLE 1

| | Wavelength | Target Focal |
|---|---|---|
| Operational Scenario | (nm) | Length (μm) |
| Video call | 540 | 95 |
| Object identification | 700 | 115 |
| Driver monitoring | 940 | 125 |

The computer 104 may determine the target focal length for an operational scenario based on environmental factors experienced by the camera 106 (e.g., temperature, humidity, ambient light, etc.). For example, as the temperature of the camera 106 changes, the lens 202 may be affected such that the electromagnetic radiation converges at different points (e.g., due to variations in the geometry of the lens 202 caused by temperature change). In such an example, the computer 104 may adjust the target focal length to compensate for the environmental factor (e.g., the computer 104 may store a separate lookup table specifying how to adjust the target focal length based on the temperature of the camera 106). That is, such a lookup table may specify different target focal lengths based on detected temperature of the camera 106. Table 2 is an example lookup table specifying varying target focal lengths based on temperature.

TABLE 2

| Wavelength | TFL (nm) | TFL (nm) | TFL (nm) |
|---|---|---|---|
| (nm) | at 0° C. | at 20° C. | at 40° C. |
| 540 | 95 | 105 | 115 |
| 700 | 115 | 125 | 135 |
| 940 | 125 | 135 | 145 |

As mentioned above, the computer 104 may select the operational scenario from a plurality of prestored operational scenarios. That is, the computer 104 may store a lookup table or the like specifying a list of possible operational scenarios and what conditions correspond to each scenario. For example, the computer 104 may determine that the vehicle is in a “driver monitoring” operational scenario in response to the vehicle 100 not being parked (and possibly other conditions). For another example, the computer 104 may determine that the vehicle is in a “video communication” scenario in response to a user of the vehicle 100 receiving a video call.

The vehicle 100 may be in more than one operational scenario simultaneously. For example, a video call may be received while the vehicle 100 is not in park, so both the “driver monitoring” operational scenario and the “video call” operational scenario occur at the same time. In this case, the computer 104 may select one of the operational scenarios based on relative priorities of the operational scenarios and/or a schedule of the operational scenarios, as will be described in turn.

The computer 104 may select the operational scenario based on a respective relative priority associated with that prestored operational scenario. Each operational scenario may have a relative priority. The computer 104 may select an operational scenario based on the relative priority of the operational scenario. That is, if there are multiple concurrent operational scenarios, the computer 104 may select the operational scenario with the highest relative priority to actuate the camera 106 accordingly. The relative priorities may, as an example, be numerically based. That is, each operational scenario may have an associated numerical score (e.g., 1-100), which is the relative priority of the operational scenario. For example, the video call operational scenario may have a relative priority of 80, and the driver monitoring operational scenario may have a relative priority of 90. In such an example, the driver monitoring operational scenario would have a higher relative priority than the video call operational scenario. The relative priorities may be preassigned and stored in the memory of the computer 104. The relative priorities may be chosen according to the effect of the associated operational scenarios on the operation of the vehicle 100 (e.g., subsystems relating directly to the operation of the vehicle 100, such as the driver monitoring system, may be given higher priority than other subsystems, such as the communications subsystem).

Additionally, or alternatively, the computer 104 may select each operational scenario according to a schedule. The schedule may specify predetermined amounts of time to select each of the operational scenarios. For example, the schedule may alternate between the driver monitoring operational scenario and the video call operational scenario. The schedule may be stored in the memory of the computer 104. The schedule may be chosen based on how much image data each vehicle subsystem needs for the operational scenario (e.g., five seconds or any amount of time determined to be sufficient to capture image data). The schedule may begin with the operational scenario having the highest relative priority.

Additionally, or alternatively, the computer 104 may select an operational scenario that includes the operations of multiple vehicle subsystems. For example, a video call may be received while the vehicle 100 is not in park, so both the “driver monitoring” operational scenario and the “video call” operational scenario occur at the same time. In such an example, the computer 104 may select an operational scenario for operation of both subsystems. Such an operational scenario may have associated wavelengths as described above. The wavelength associated with an operational scenario for more than one vehicle subsystem may be, for example, a wavelength between the wavelengths specified by the respective subsystem specifications (e.g., if a first subsystem specifies 700 nm and a second subsystem specifies 900 nm, the wavelength associated with the operational scenario may be in the range of 700 nm-900 nm). The wavelength between the wavelengths specified by the respective subsystem specifications may be determined to minimize reduction in image quality. For example, the wavelength may be the mean of the specified wavelengths (e.g., if a first subsystem specifies 700 nm and a second subsystem specifies 900 nm, the wavelength associated with the operational scenario may be 800 nm).

The computer 104 determines the target focal length based on the operational scenario. For example, the computer 104 may store a plurality of possible target focal lengths (e.g., a first target focal length, a second target focal length, etc.). The possible target focal lengths are associated in memory with respective prestored operational scenarios (e.g., as in Table 1 above). The computer 104 may, in response to selecting one of the prestored operational scenarios, determine that the target focal length is the possible target focal length associated with the selected operational scenario (e.g., determining that the target focal length is the first target focal length in response to selecting a first operational scenario, determining that the target focal length is the second target focal length in response to selecting a second operational scenario, etc.). The possible target focal lengths stored in memory may be chosen such that the focal plane 206 is located at the convergence of the wavelength of light associated with the respective operational scenario. The lens 202 may converge different wavelengths at different distances from the lens based on the characteristics of the lens (e.g., refractive index) as shown in FIG. 2.

The computer 104 may actuate the camera 106 to adjust the focal length to the target focal length. The computer 104 may actuate the camera 106 to move the lens 202 or the image sensor which is the focal plane 206 to adjust the distance between the lens 202 and the focal plane 206. For example, the computer 104 may actuate motors of the camera 106 which support a housing of the lens 202 to increase or decrease the focal length 204 to the focal plane 206. For example, the computer 104 may determine a voltage value based on the target wavelength and apply the voltage value to the motors of the camera 106. The computer 104 may determine the voltage value based on a difference between the current focal length and the target focal length. The computer 104 may store a table of ranges of differences and associated voltage values.

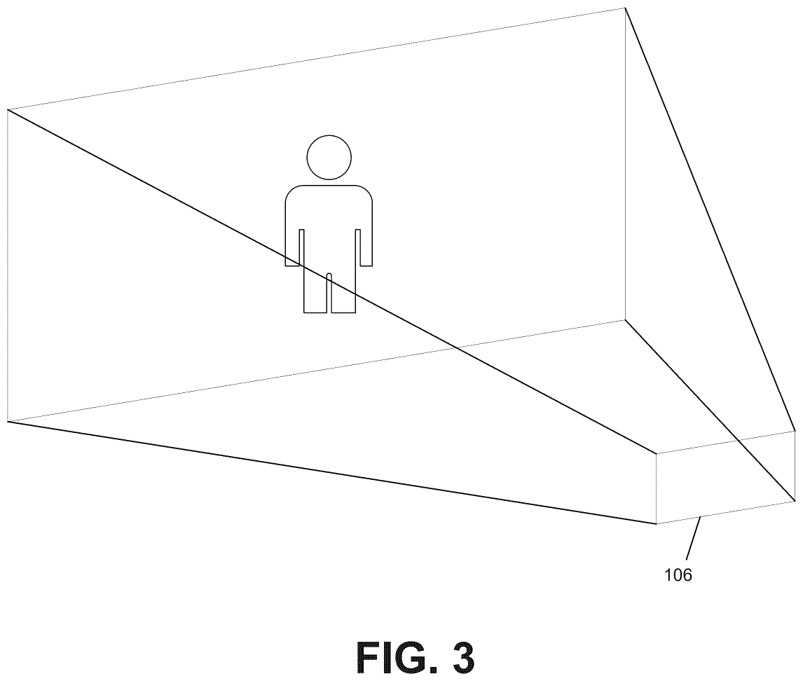

With reference to FIG. 3, the computer 104 receives image data from the camera 106. The image data are a sequence of image frames of the field of view of the camera 106. Each image frame is a two-dimensional matrix of pixels. Each pixel has a brightness or color represented as one or more numerical values, such as a scalar unitless value of photometric light intensity between 0 (black) and 1 (white), or values for each of red, green, and blue (e.g., each on an 8-bit scale (0 to 255) or a 12- or 16-bit scale). The pixels may be a mix of representations (e.g., a repeating pattern of scalar values of intensity for three pixels and a fourth pixel with three numerical color values, or some other pattern). Position in an image frame (i.e., position in the field of view of the sensor at the time that the image frame was recorded) can be specified in pixel dimensions or coordinates (e.g., an ordered pair of pixel distances), such as a number of pixels from a top edge and a number of pixels from a left edge of the image frame.

FIG. 3 shows example image data captured by the camera 106. After adjusting the focal length 204, the computer 104 may actuate the camera 106 to capture the image data. The image data may be of any environment corresponding to the field of view of the camera 106. As an example, the environment may include an operator of the vehicle 102.

The camera 106 may filter out bands of wavelengths when capturing image data. For example, the camera 106 may use a wavelength filter (e.g., one or more bandpass filters). Alternatively, or additionally, the computer 104 may filter out bands of wavelengths from the image data (e.g., via digital manipulation). The computer 104 may remove, by the wavelength filter, wavelengths of light outside of a variance threshold measured with respect to the wavelength of light associated with the operational scenario from the image data. The variance threshold may be a preset range stored in the memory of the computer 104. The variance threshold may be chosen to produce image data acceptable for use in the respective operational scenario. As an example, the variance threshold may be 40 nm. In this example, if the wavelength associated with the operational scenario is 560 nm, then the computer 104 may filter out any wavelengths that are less than 520 nm or greater than 600 nm. As another example, the variance threshold may be 1 nm such that substantially all wavelengths other than the specified wavelength are filtered from the image data.

The computer 104 may adjust the image data to compensate for field of view variation resulting from adjusting the focal length 204. Field of view refers to the area or environment captured by the camera 106 in the image data. Field of view is increased as focal length 204 is decreased. Therefore, as the computer 104 adjusts the focal length 204, the field of view of the image data is affected. Accordingly, the computer 104 may compensate for changes in the field of view. For example, the computer 104 may “trim” all image data (e.g., by removing pixels around the margins of the image data) to have the same field of view. Continuing with the example, image data captured at a shorter focal length 204 may have fewer pixels removed than image data captured at a longer focal length 204. The pixel area to be removed may correspond to the focal length 204. The pixel area to be removed for each operational scenario (i.e., for each focal lengths 204) may be stored in the memory of the computer 104.

The computer 104 may actuate one or more components 108 of the vehicle 100 according to the operational scenario. Each operational scenario may have associated components 108 and specified operations for the components 108. As an example, the computer 104 may store a lookup table specifying how to actuate specific vehicle subsystems based on the operational scenario and the captured image data. As a further example, if the operational scenario is a driver monitoring operational scenario, the computer 104 may actuate the display 110 to output a message to the operator (e.g., based on a state of the operator as determined by the computer 104 based on the image data.) For another example, if the operational scenario is a video call operational scenario, the computer 104 may actuate a transceiver to transmit the image data as well as audio data for a video call.

### Example Process

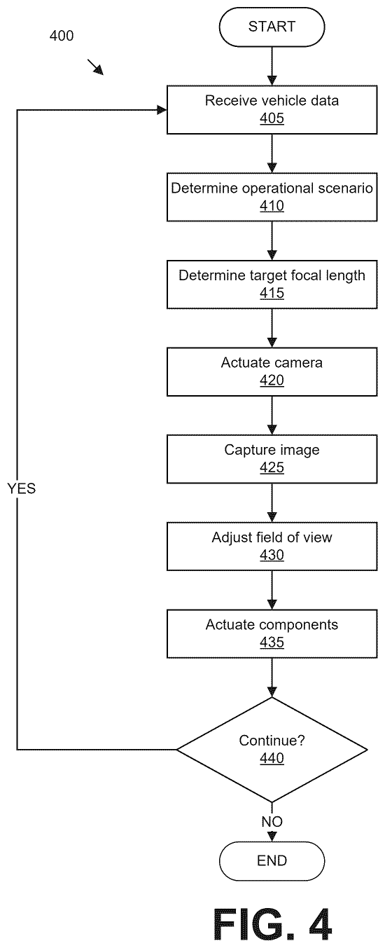

FIG. 4 is a flowchart illustrating an example process 400 for adjusting the focal length 204 of the camera 106. The memory of the computer 104 stores executable instructions for performing the steps of the process 400 and/or programming can be implemented in structures such as mentioned above. As a general overview of the process 400, the computer receives data through the communications network 114, determines the operational scenario, determines the target focal length, actuates the camera 106 to adjust the focal length 204 to the target focal length, receives the image data from the camera 106, adjusts the field of view, and actuates the components 108 based on the image data. The process 400 may continue for as long as the vehicle 100 remains on.

The process 400 begins in a block 405, in which the computer 104 data through the communications network 114. The data may be related to the conditions for the operational scenarios, as described above.

Next, in a block 410, the computer 104 determines the operational scenario, as described above.

Next, in a block 415, the computer 104 determines the target focal length, as described above.

Next, in a block 420, the computer 104 actuates the camera 106 to adjust the focal length 204 to the target focal length, as described above.

Next, in a block 425, the computer 104 receives the image data from the camera 106 captured with the focal length 204 at the target focal length, as described above.

Next, in a block 430, the computer 104 adjusts the field of view of the image data, as described above.

Next, in a block 435, the computer 104 actuates the component 108 based on the image data captured with the focal length 204 at the target focal length, as described above.

Next, in a decision block 440, the computer 104 determines whether to continue the process 400. For example, the computer 104 may determine whether the vehicle 100 is still on. In response to the vehicle 100 still being on, the process 400 returns to the block 405 to update the selection of the operational scenario and re-adjust the focal length 204. In response to the vehicle 100 turning off, the process 400 ends.

Computing devices such as those discussed herein generally each includes commands executable by one or more computing devices such as those identified above, and for carrying out blocks or steps of processes described above. For example, process blocks discussed above may be embodied as computer executable commands.

Computer executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands (i.e., from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer 104 (i.e., by a processor of a computer 104). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer 104. Common forms of computer-readable media include, for example, RAM, a PROM, an EPROM, a FLASH-EEPROM, any other memory chip or cartridge, or any other medium from which a computer 104 can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Use of in response to, based on, and upon determining herein indicates a causal relationship, not merely a temporal relationship. “Based on” or “in response to” can mean based at least partly on or at least partly in response to unless explicitly stated otherwise.

Examples are contemplated herein. Any example embodiment or feature described herein is not necessarily to be construed as preferred or advantageous over other embodiments or features. Further, the example embodiments described herein are not meant to be limiting. It will be readily understood that certain aspects of the disclosed systems and methods can be arranged and combined in a wide variety of different configurations, all of which are contemplated herein. In addition, the particular arrangements shown in the Figures should not be viewed as limiting. It should be understood that other embodiments might include more or less of each element shown in a given Figure. Additionally, some of the illustrated elements may be combined or omitted. Yet further, an example embodiment may include elements that are not illustrated in the Figures.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described. The adjectives “first” and “second” are used throughout this document as identifiers and are not intended to signify importance, order, or quantity. Use of “in response to,” “upon determining,” etc. indicates a causal relationship, not merely a temporal relationship. Operations, systems, and methods described herein should always be implemented and/or performed in accordance with an applicable user's manual and/or guidelines.

1. A system comprising a computer having a processor and a memory, the memory storing instructions executable by the processor to:
based on an operational scenario of a vehicle, determine a target focal length, the vehicle including a camera having an adjustable focal length;
actuate the camera to adjust the adjustable focal length to the target focal length; and
actuate the camera to capture image data while the adjustable focal length of the camera is at the target focal length;
wherein the target focal length corresponds to a wavelength of light associated with the operational scenario.

2. The system of claim 1, wherein the wavelength associated with the operational scenario is based on a specification of a vehicle subsystem.

3. The system of claim 2, wherein the specification is a specified light wavelength of the vehicle subsystem.

4. The system of claim 1, wherein the operational scenario is that an occupant of the vehicle is on a video call.

5. The system of claim 1, wherein the operational scenario is monitoring a status of an operator of the vehicle.

6. The system of claim 1, wherein the wavelength of light associated with the operational scenario is near-infrared light.

7. The system of claim 1, wherein the wavelength of light associated with the operational scenario is visible light.

8. The system of claim 1, wherein the wavelength of light associated with the operational scenario is shortwave infrared light.

9. The system of claim 1, the instructions including further instructions to select the operational scenario from a plurality of prestored operational scenarios.

10. The system of claim 9, wherein each of the prestored operational scenarios has a respective relative priority associated with that prestored operational scenario, and the instructions further include instructions to select the operational scenario from the prestored operational scenarios based on the relative priorities.

11. The system of claim 9, wherein the prestored operational scenarios include a first prestored operational scenario and a second prestored operational scenario, the instructions further including instructions to determine that the target focal length is a first target focal length in response to selecting the first prestored operational scenario as the operational scenario, and determine that the target focal length is a second target focal length in response to selecting the second prestored operational scenario as the operational scenario.

12. The system of claim 9, wherein the wavelength of light is selected from a first wavelength of light associated with a first operational scenario and a second wavelength of light associated with a second operational scenario.

13. The system of claim 9, wherein the prestored operational scenarios include a first prestored operational scenario and a second prestored operational scenario, the instructions further including instructions to determine that the target focal length is between a first target focal length of the first prestored operational scenario and a second target focal length of the second prestored operational scenario.

14. A method comprising:
based on an operational scenario of a vehicle, determining a target focal length, the vehicle including a camera having an adjustable focal length;
actuating the camera to adjust the adjustable focal length to the target focal length; and
actuating the camera to capture image data while the adjustable focal length of the camera is at the target focal length;
wherein the target focal length corresponds to a wavelength of light associated with the operational scenario.

15. The method of claim 14, wherein the wavelength associated with the operational scenario is based on a specification of a vehicle subsystem.

16. The method of claim 14, further comprising selecting the operational scenario from a plurality of prestored operational scenarios.

17. The method of claim 16, wherein each of the prestored operational scenarios has a respective relative priority associated with that prestored operational scenario, and further comprising selecting the operational scenario from the prestored operational scenarios based on the relative priorities.

18. The method of claim 16, wherein the prestored operational scenarios include a first prestored operational scenario and a second prestored operational scenario, and further comprising determining that the target focal length is a first target focal length in response to selecting the first prestored operational scenario as the operational scenario, and determining that the target focal length is a second target focal length in response to selecting the second prestored operational scenario as the operational scenario.

19. The method of claim 16, wherein the wavelength of light is selected from a first wavelength of light associated with a first operational scenario and a second wavelength of light associated with a second operational scenario.

20. The method of claim 16, wherein the prestored operational scenarios include a first prestored operational scenario and a second prestored operational scenario, further comprising determining that the target focal length is between a first target focal length of the first prestored operational scenario and a second target focal length of the second prestored operational scenario.
